(19) United States
(12) Patent Application Publication
(10) Pub. No.: US 2021/0405802 A1
(43) Pub. Date: Dec. 30, 2021

(54) PRESSURE SENSING MODULE, ITS MANUFACTURING METHOD, AND ELECTRONIC DEVICE

(71) Applicant: BOE TECHNOLOGY GROUP CO., LTD., Beijing (CN)

(72) Inventor: Yuanzheng GUO, Beijing (CN)

(73) Assignee: BOE TECHNOLOGY GROUP CO., LTD., Beijing (CN)

(21) Appl. No.: 16/498,154

(22) PCT Filed: Apr. 3, 2019
(86) PCT No.: PCT/CN2019/081230

§ 371 Date: Sep. 26, 2019

(30) Foreign Application Priority Data
Jun. 7, 2018 (CN) 201810579465.5

(51) Int. Cl. G06F 3/041

(52) U.S. Cl. CPC G06F 3/0414; G06F 2203/04102; G06F 2203/04103

(57) ABSTRACT

The present disclosure provides a pressure sensing module, a manufacturing method thereof, and an electronic device. The method includes: providing a support plate; forming a flexible thin film on the support plate; forming first pressure sensing electrodes and second pressure sensing electrodes on the flexible thin film and at different levels, each second pressure sensing electrode being arranged at a position corresponding to a gap between two adjacent first pressure sensing electrodes, a distance between each first pressure sensing electrode and a corresponding second pressure sensing electrode being capable of changing under the effect of a pressure; forming a flexible protection film covering the first pressure sensing electrodes and the second pressure sensing electrodes; and removing the flexible thin film from the support plate.

### CROSS-REFERENCE TO RELATED APPLICATION

The present application claims a priority of the Chinese patent application No. 201810579465.5 filed on Jun. 7, 2018, which is incorporated herein by reference in its entirety.

### TECHNICAL FIELD

The present disclosure relates to the field of pressure sensing technology, in particular to a pressure sensing module, a manufacturing method thereof, and an electronic device.

### BACKGROUND

Recently, along with the rapid development of flexible display products, the mass production of the flexible display products is in full swing for many manufacturers. Due to the mature of the flexible display product, a flexible pressure sensing module is highly demanded. In addition, along with the development of the robots, especially humanoid robots, a mechanism arm is required to accurately sensing a size of a force when picking up an object, so as to match an operation for picking up the object. At this time, the flexible pressure sensing module is also highly demanded.

### SUMMARY

In one aspect, the present disclosure provides in some embodiments a method for manufacturing a pressure sensing module, including: providing a support plate; forming a flexible thin film on the support plate; forming first pressure sensing electrodes and second pressure sensing electrodes on the flexible thin film and at different levels, each second pressure sensing electrode being arranged at a position corresponding to a gap between two adjacent first pressure sensing electrodes, a distance between each first pressure sensing electrode and a corresponding second pressure sensing electrode being capable of changing under the effect of a pressure; forming a flexible protection film covering the first pressure sensing electrodes and the second pressure sensing electrodes; and removing the flexible thin film from the support plate.

In some possible embodiments of the present disclosure, when each second pressure sensing electrode is arranged at a position corresponding to the gap between the two adjacent first pressure sensing electrodes, an orthogonal projection of the second pressure sensing electrode onto the support plate is located between, and does not overlap, orthogonal projections of the two adjacent first pressure sensing electrodes onto the support plate.

In some possible embodiments of the present disclosure, when each second pressure sensing electrode is arranged at a position corresponding to the gap between the two adjacent first pressure sensing electrodes, an orthogonal projection of the second pressure sensing electrode onto the support plate is located between, and partially overlaps, orthogonal projections of the two adjacent first pressure sensing electrodes onto the support plate.

In some possible embodiments of the present disclosure, the forming the flexible thin film on the support plate includes: forming a release layer on the support plate; and forming the flexible thin film on the release layer.

In some possible embodiments of the present disclosure, the forming the first pressure sensing electrodes and the second pressure sensing electrodes on the flexible thin film and at different levels includes: forming the first pressure sensing electrodes on the flexible thin film and spaced apart from each other; forming a first flexible layer covering the first pressure sensing electrodes; forming the second pressure sensing electrodes on the first flexible layer and spaced apart from each other; and removing at least a part of the first flexible layer between the adjacent second pressure sensing electrodes.

In some possible embodiments of the present disclosure, the forming the first pressure sensing electrodes and the second pressure sensing electrodes on the flexible thin film and at different levels includes: forming the first pressure sensing electrodes on the flexible thin film and spaced apart from each other; forming a first flexible layer covering the first pressure sensing electrodes; forming the second pressure sensing electrodes on the first flexible layer and spaced apart from each other; forming a second flexible layer covering the second pressure sensing electrodes; and removing the second flexible layer between the adjacent second pressure sensing electrodes and at least a part of the first flexible layer between the adjacent second pressure sensing electrodes.

In some possible embodiments of the present disclosure, the removing at least a part of the first flexible layer between the adjacent second pressure sensing electrodes includes removing a part of the first flexible layer corresponding to a gap between the adjacent second pressure sensing electrodes, or removing the entire first flexible layer corresponding to the gap between the adjacent second pressure sensing electrodes, so as to expose the corresponding first pressure sensing electrode.

In some possible embodiments of the present disclosure, the forming the first pressure sensing electrodes and the second pressure sensing electrodes on the flexible thin film and at different levels includes forming the first pressure sensing electrodes and the second pressure sensing electrodes, each of which is made of metal, on the flexible thin film and at different levels.

In another aspect, the present disclosure provides in some embodiments a pressure sensing module, including: a flexible thin film; first pressure sensing electrodes and second pressure sensing electrodes arranged on the flexible thin film and at different levels, each second pressure sensing electrode being arranged at a position corresponding to a gap between two adjacent first pressure sensing electrodes, a distance between each first pressure sensing electrode and a corresponding second pressure sensing electrode being capable of changing under the effect of a pressure; and a flexible protection film covering the first pressure sensing electrodes and the second pressure sensing electrodes.

In some possible embodiments of the present disclosure, the pressure sensing module includes: the flexible thin film; the first pressure sensing electrodes arranged on the flexible thin film and spaced apart from each other; a pattern of a first flexible layer, the pattern of the first flexible layer including a plurality of concaves and convexes arranged alternately, each concave corresponding to a corresponding first pressure sensing electrode; and the second pressure sensing electrodes each arranged on a corresponding convex.

In some possible embodiments of the present disclosure, the pressure sensing module further includes a pattern of a second flexible layer covering the second pressure sensing electrodes, and an orthogonal projection of the pattern of the second flexible layer onto the flexible thin film falls within orthogonal projections of the convexes onto the flexible thin film.

In some possible embodiments of the present disclosure, the flexible thin film, the first flexible layer and the second flexible layer are each made of polyimide.

In some possible embodiments of the present disclosure, the flexible thin film, the first flexible layer and the second flexible layer are each made of transparent polyimide or yellow polyimide.

In some possible embodiments of the present disclosure, an orthogonal projection of the gap between the adjacent first pressure sensing electrodes onto the flexible thin film falls within an orthogonal projection of a corresponding second pressure sensing electrode onto the flexible thin film.

In some possible embodiments of the present disclosure, the orthogonal projection of the second pressure sensing electrode onto the flexible thin film falls within the orthogonal projection of the gap between the adjacent first pressure sensing electrodes onto the flexible thin film.

In some possible embodiments of the present disclosure, the orthogonal projection of the gap between the adjacent first pressure sensing electrodes onto the flexible thin film coincides with the orthogonal projection of the corresponding second pressure sensing electrode onto the flexible thin film.

In some possible embodiments of the present disclosure, the flexible thin film has a thickness of 5 μm to 20 μm, the first flexible layer has a thickness of 1 μm to 10 μm, and the second flexible layer has a thickness of 5 μm to 20 μm.

In yet another aspect, the present disclosure provides in some embodiments an electronic device including the above-mentioned pressure sensing module.

In some possible embodiments of the present disclosure, when the pressure sensing module is applied to an optical display product, the flexible thin film, the first flexible layer and the second flexible layer of the pressure sensing module are each made of transparent polyimide.

In some possible embodiments of the present disclosure, when the pressure sensing module is applied to a robot or a wearable device, the flexible thin film, the first flexible layer and the second flexible layer of the pressure sensing module are each made of yellow polyimide.

### BRIEF DESCRIPTION OF THE DRAWINGS

In order to illustrate the technical solutions of the present disclosure or the related art in a clearer manner, the drawings desired for the present disclosure or the related art will be described hereinafter briefly. Obviously, the following drawings merely relate to some embodiments of the present disclosure, and based on these drawings, a person skilled in the art may obtain the other drawings without any creative effort.

FIG. 1 is a schematic view showing a pressure sensing module after the formation of a release layer and a flexible thin film on a support plate according to some embodiments of the present disclosure;

FIG. 2 is a schematic view showing the pressure sensing module after the formation of first pressure sensing electrodes according to some embodiments of the present disclosure;

FIG. 3 is a schematic view showing the pressure sensing module after the formation of a first flexible layer according to some embodiments of the present disclosure;

FIG. 4 is a schematic view showing the pressure sensing module after the formation of second pressure sensing electrodes according to some embodiments of the present disclosure;

FIG. 5 is a schematic view showing the pressure sensing module after etching the first flexible layer according to some embodiments of the present disclosure;

FIG. 6 is a schematic view showing the pressure sensing module after the formation of a flexible protection film according to some embodiments of the present disclosure;

FIG. 7 is a schematic view showing the pressure sensing module after the removal of the flexible thin film from the support plate according to some embodiments of the present disclosure;

FIG. 8 is a schematic view showing the pressure sensing module after the formation of a second flexible layer according to some embodiments of the present disclosure;

FIG. 9 is a schematic view showing the pressure sensing module after etching the first flexible layer and the second flexible layer according to some embodiments of the present disclosure;

FIG. 10 is a schematic view showing the pressure sensing module after the formation of the flexible protection film according to some embodiments of the present disclosure; and

FIG. 11 is a schematic view showing the pressure sensing module after the removal of the flexible thin film from the support plate according to some embodiments of the present disclosure.

### REFERENCE SIGN LIST

1 support plate
2 release layer
3 flexible thin film
4 first pressure sensing electrode
5 first flexible layer
6 second pressure sensing electrode
7 second flexible layer
8 flexible protection film

### DETAILED DESCRIPTION

In order to make the objects, the technical solutions and the advantages of the present disclosure more apparent, the present disclosure will be described hereinafter in a clear and complete manner in conjunction with the drawings and embodiments.

A pressure sensing module, a manufacturing method thereof and an electronic device in the embodiments of the present disclosure may be applied to a flexible display product, a robot or a wearable device.

The present disclosure provides in some embodiments a method for manufacturing a pressure sensing module which includes: providing a support plate; forming a flexible thin film on the support plate; forming first pressure sensing electrodes and second pressure sensing electrodes on the flexible thin film and at different levels, each second pressure sensing electrode being arranged at a position corresponding to a gap between two adjacent first pressure sensing electrodes, a distance between each first pressure sensing electrode and a corresponding second pressure sensing electrode being capable of changing under the effect of a pressure; forming a flexible protection film covering the first pressure sensing electrodes and the second pressure sensing electrodes; and removing the flexible thin film from the support plate.

Here, when each second pressure sensing electrode is arranged at a position corresponding to the gap between the two adjacent first pressure sensing electrodes, an orthogonal projection of the second pressure sensing electrode onto the support plate is located between, and does not overlap, orthogonal projections of the two adjacent first pressure sensing electrodes onto the support plate, or the orthogonal projection of the second pressure sensing electrode onto the support plate is located between, and partially overlaps, the orthogonal projections of the two adjacent first pressure sensing electrodes onto the support plate.

According to the embodiments of the present disclosure, the pressure sensing module may include the first pressure sensing electrodes and the second pressure sensing electrodes arranged on the flexible thin film, and the distance between each first pressure sensing electrode and the corresponding second pressure sensing electrode may change under the effect of the pressure. At this time, a capacitance between the first pressure sensing electrode and the corresponding second pressure sensing electrode may change too, so as to convert a pressure signal into an electrical signal, thereby to achieve a pressure detection function. In addition, the pressure sensing module may include the flexible thin film, the first pressure sensing electrodes and the second pressure sensing electrodes, and each of the first pressure sensing electrodes and the second pressure sensing electrodes are made of metal. As a result, the pressure sensing module is flexible and resistant to high and low temperatures, so it may be applied to a flexible display product, a robot and a wearable device.

The flexible thin film is removed from the support plate in a mechanical mode or a laser lift off (LLO) mode. When the flexible thin film is removed from the support plate in the mechanical mode, it is necessary to form a release layer between the flexibly thin film and the support plate in advance, so as to reduce an adhesive force between the flexible thin film and the support plate. Prior to forming the flexible thin film on the support plate, the method may further include forming the release layer on the support plate. The forming the flexible thin film on the support plate may include forming the flexible thin film on the release layer. The release layer is made of an inorganic insulation material.

In a possible embodiment of the present disclosure, the forming the first pressure sensing electrodes and the second pressure sensing electrodes on the flexible thin film and at different levels may include: forming the first pressure sensing electrodes on the flexible thin film and spaced apart from each other; forming a first flexible layer covering the first pressure sensing electrodes; forming the second pressure sensing electrodes on the first flexible layer and spaced apart from each other, each second pressure sensing electrode being arranged at a position corresponding to the gap between the adjacent first pressure sensing electrodes; and removing at least a part of the first flexible layer between the adjacent second pressure sensing electrodes.

In another possible embodiment of the present disclosure, the forming the first pressure sensing electrodes and the second pressure sensing electrodes on the flexible thin film and at different levels may include: forming the first pressure sensing electrodes on the flexible thin film and spaced apart from each other; forming a first flexible layer covering the first pressure sensing electrodes; forming the second pressure sensing electrodes on the first flexible layer and spaced apart from each other, each second pressure sensing electrode being arranged at a position corresponding to the gap between the adjacent first pressure sensing electrodes; forming a second flexible layer covering the second pressure sensing electrodes; and removing the second flexible layer between the adjacent second pressure sensing electrodes and at least a part of the first flexible layer between the adjacent second pressure sensing electrodes.

Each of the flexible thin film, the first flexible layer and the second flexible layer are made of an organic material, preferably polyimide. Polyimide has excellent chemical stability and mechanical property, and it is insoluble in an organic solvent and stable to a dilute acid. In addition, no cracks or wrinkles may occur when the layer made of polyimide is bent many times. Furthermore, the layer made of polyimide is resistant to high and low temperatures, i.e., it may operate at a temperature below 0° C., and operate for a long term at a temperature of 400° C. A specific reliable usage range is associated with the characteristics of the polyimide material. Polyimide may include transparent polyimide (fluorine-containing polyimide) and yellow polyimide (aromatic polyimide). Transparent polyimide is capable of existing stably at a temperature within the range of 0° C. to 200° C., and yellow polyimide is capable of existing stably at a temperature within the range of 0° C. to 400° C. When each of the flexible thin film, the first flexible layer and the second flexible layer is made of transparent polyimide, the resultant pressure sensing module is applied to the display product. When each of the flexible thin film, the first flexible layer and the second flexible layer is made of yellow polyimide, the resultant pressure sensing module is applied to a non-optical field, e.g., a robot or a wearable device, and it may have better solvent resistance, better high/low temperature resistance and better mechanical performance.

The present disclosure further provides in some embodiments a pressure sensing module which includes: a flexible thin film; first pressure sensing electrodes and second pressure sensing electrodes arranged on the flexible thin film and at different levels, each second pressure sensing electrode being arranged at a position corresponding to a gap between two adjacent first pressure sensing electrodes, a distance between each first pressure sensing electrode and a corresponding second pressure sensing electrode being capable of changing under the effect of a pressure; and a flexible protection film covering the first pressure sensing electrodes and the second pressure sensing electrodes.

According to the embodiments of the present disclosure, the pressure sensing module may include the first pressure sensing electrodes and the second pressure sensing electrodes arranged on the flexible thin film, and the distance between each first pressure sensing electrode and the corresponding second pressure sensing electrode may change under the effect of the pressure. At this time, a capacitance between the first pressure sensing electrode and the corresponding second pressure sensing electrode may change too, so as to convert a pressure signal into an electrical signal, thereby to achieve a pressure detection function. In addition, the pressure sensing module may include the flexible thin film, the first pressure sensing electrodes and the second pressure sensing electrodes, and each of the first pressure sensing electrodes and the second pressure sensing electrodes are made of metal. As a result, the pressure sensing module is flexible and resistant to high and low temperatures, so it can be applied to a flexible display product, a robot and a wearable device.

In some possible embodiments of the present disclosure, the pressure sensing module may include: the flexible thin film; the first pressure sensing electrodes arranged on the flexible thin film and spaced apart from each other; a pattern of a first flexible layer, the pattern of the first flexible layer including a plurality of concaves and convexes arranged alternately, each concave corresponding to a corresponding first pressure sensing electrode; and the second pressure sensing electrodes each arranged on a corresponding convex.

In another possible embodiment of the present disclosure, the pressure sensing module may further include a pattern of a second flexible layer covering the second pressure sensing electrodes, and an orthogonal projection of the pattern of the second flexible layer onto the flexible thin film may fall within orthogonal projections of the convexes onto the flexible thin film.

Further, each of the flexible thin film, the first flexible layer and the second flexible layer is made of polyimide.

Each of the flexible thin film, the first flexible layer and the second flexible layer is made of an organic material, preferably polyimide. Polyimide has excellent chemical stability and mechanical property, and it is insoluble in an organic solvent and stable to a dilute acid. In addition, no cracks or wrinkles may occur when the layer made of polyimide is bent many times. Furthermore, the layer made of polyimide is resistant to high and low temperatures, i.e., it may operate at a temperature below 0° C., and operate for a long term at a temperature of 400° C. A specific reliable usage range is associated with the characteristics of the polyimide material. Polyimide may include transparent polyimide (fluorine-containing polyimide) and yellow polyimide (aromatic polyimide). Transparent polyimide is capable of existing stably at a temperature within the range of 0° C. to 200° C., and yellow polyimide is capable of existing stably at a temperature within the range of 0° C. to 400° C. When each of the flexible thin film, the first flexible layer and the second flexible layer is made of transparent polyimide, the resultant pressure sensing module is applied to the display product. When each of the flexible thin film, the first flexible layer and the second flexible layer is made of yellow polyimide, the resultant pressure sensing module is applied to a non-optical field, e.g., a robot or a wearable device, and it may have better solvent resistance, better high/low temperature resistance and better mechanical performance.

Further, the flexible thin film may have a thickness of 5 μm to 20 μm, the first flexible layer may have a thickness of 1 μm to 10 μm, and the second flexible layer may have a thickness of 5 μm to 20 μm.

The pressure sensing module and the manufacturing method thereof will be described hereinafter in conjunction with the drawings and embodiments.

### First Embodiment

The method for manufacturing the pressure sensing module in this embodiment may include the following steps.

Step 1: as shown in FIG. 1, forming a release layer 2 and a flexible thin film 3 on a support plate 1.

The support plate 1 is a glass substrate or a quartz substrate. The release layer 2 is made of an inorganic insulation material. The flexible thin film 3 is made of polyimide, and has a thickness of 5 μm to 20 μm.

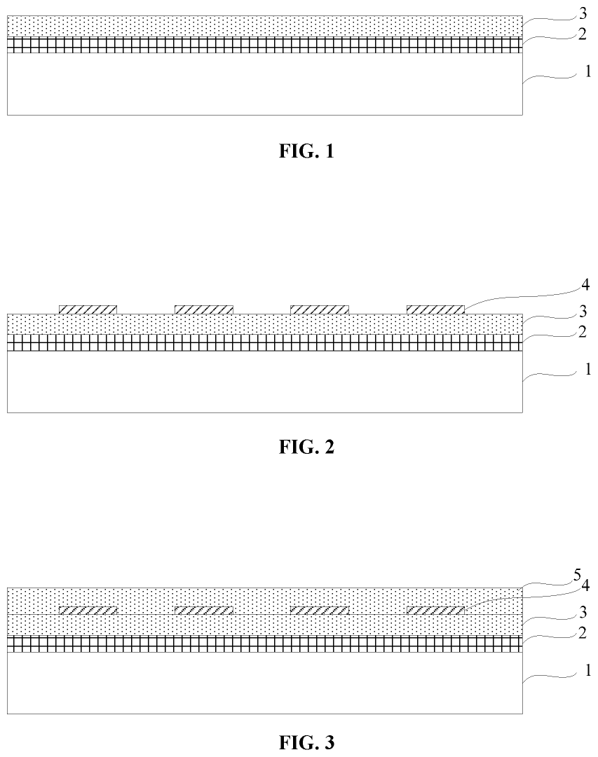

Step 2: as shown in FIG. 2, forming first pressure sensing electrodes 4 and a signal line.

To be specific, a metal layer is deposited onto the flexible thin film 3 through sputtering or thermal evaporation. The metal layer is made of Cu, Al, Ag, Mo, Cr, Nd, Ni, Mn, Ti, Ta, W or an alloy thereof, and it is of a single-layered structure, or a multi-layered structure such as Cu/Mo, Ti/Cu/Ti, Mo/Al/Mo or Ti/Al/Ti. Next, a photoresist is applied onto the metal layer, and exposed through a mask plate, so as to form a photoresist reserved region corresponding a region where patterns of the first pressure sensing electrodes 4 and the signal line are located and a photoresist unreserved region corresponding to the other region. Next, the photoresist is developed, so as to fully remove the photoresist at the photoresist unreserved region, and maintain the photoresist at the photoresist reserved region. Finally, the metal layer at the photoresist unreserved region is etched off through an etching process, and the remaining photoresist is removed, so as to form the first pressure sensing electrodes 4 and the signal line. The first pressure sensing electrodes 4 are arranged on the flexible thin film 3 and spaced apart from each other. One end of the signal line is connected to each first pressure sensing electrode 4, and the other end is connected to a processing circuit.

Of course, each first pressure sensing electrode may also be made of a transparent conductive material, e.g., indium tin oxide (ITO), but not limited to metal.

Step 3: as shown in FIG. 3, forming a first flexible layer 5.

The first flexible layer 5 is made of polyimide, and has a thickness of 1 μm to 10 μm. The thickness of the first flexible layer 5 may depend on a capacitance between each first pressure sensing electrode 4 and a corresponding second pressure sensing electrode 6.

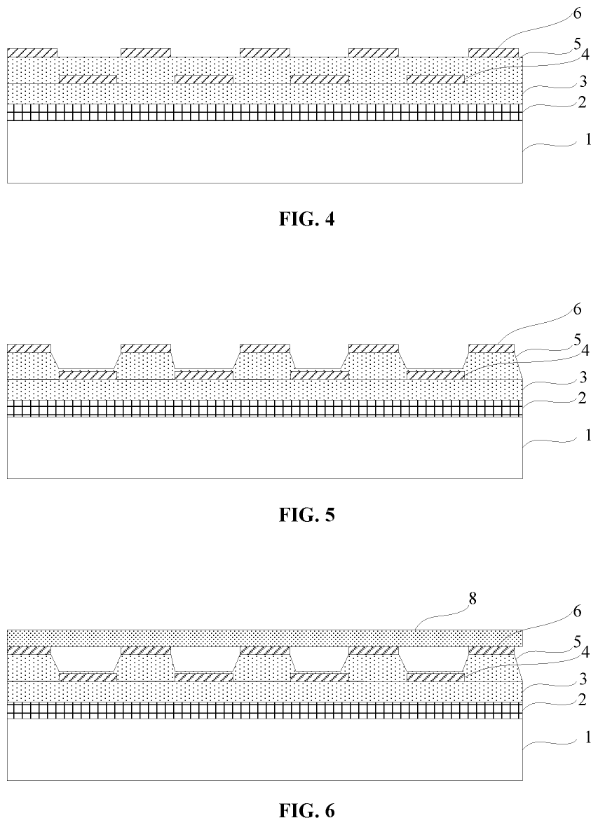

Step 4: as shown in FIG. 4, forming the second pressure sensing electrodes 6 and a signal line.

To be specific, a metal layer is deposited onto the first flexible layer 5 through sputtering or thermal evaporation. The metal layer is made of Cu, Al, Ag, Mo, Cr, Nd, Ni, Mn, Ti, Ta, W or an alloy thereof, and it is of a single-layered structure, or a multi-layered structure such as Cu/Mo, Ti/Cu/Ti, Mo/Al/Mo or Ti/Al/Ti. Next, a photoresist is applied onto the metal layer, and exposed through a mask plate, so as to form a photoresist reserved region corresponding a region where patterns of the second pressure sensing electrodes 6 and the signal line are located and a photoresist unreserved region corresponding to the other region. Next, the photoresist is developed, so as to fully remove the photoresist at the photoresist unreserved region, and maintain the photoresist at the photoresist reserved region. Finally, the metal layer at the photoresist unreserved region is etched off through an etching process, and the remaining photoresist is removed, so as to form the second pressure sensing electrodes 6 and the signal line. The second pressure sensing electrodes 6 are arranged on the first flexible layer 5 and spaced apart from each other. A capacitor is formed between each second pressure sensing electrode 6 and the corresponding first pressure sensing electrode 4. Each second pressure sensing electrode 6 is arranged at a position corresponding to a gap between the adjacent first pressure sensing electrodes 4. An orthogonal projection of the gap between the adjacent first pressure sensing electrodes 4 onto the flexible thin film may fall within an orthogonal protection of the corresponding second pressure sensing electrode 6 onto the flexible thin film, or the orthogonal projection of each second pressure sensing electrode 6 onto the flexible thin film may fall within the orthogonal projection of the gap between the adjacent first pressure sensing electrodes 4 onto the flexible thin film, or the orthogonal protection of the gap between the adjacent first pressure sensing electrodes 4 onto the flexible thin film may coincide with the orthogonal projection of the corresponding second pressure sensing electrode 6 onto the flexible thin film. One end of the signal line is connected to each second pressure sensing electrode 4, and the other end is connected to the processing circuit.

Of course, each second pressure sensing electrode may also be made of a transparent conductive material, e.g., ITO, but not limited to metal.

Step 5: as shown in FIG. 5, removing at least a part of the first flexible layer 5 at a gap between the adjacent second pressure sensing electrodes 6.

A part of the first flexible layer 5 or the entire first flexible layer 5 at the gap between the adjacent second pressure sensing electrodes 6 is removed, so as to expose the corresponding first pressure sensing electrode 4. Through removing at least a part of the first flexible layer 5 at the gap between the adjacent second pressure sensing electrodes 6, a pattern of the island-like first flexible layer 5 is formed. Hence, the pattern of first flexible layer 5 is deformed under the effect of a pressure, so a distance between each first pressure sensing electrode 4 and the corresponding second pressure sensing electrode 6 may change. At this time, a capacitance between each first pressure sensing electrode 4 and the corresponding second pressure sensing electrode 6 may change too, so as to convert a pressure signal into an electrical signal, thereby to achieve a pressure detection function.

Step 6: as shown in FIG. 6, forming a flexible protection film 8. The flexible protection film 8 may also be made of polyimide.

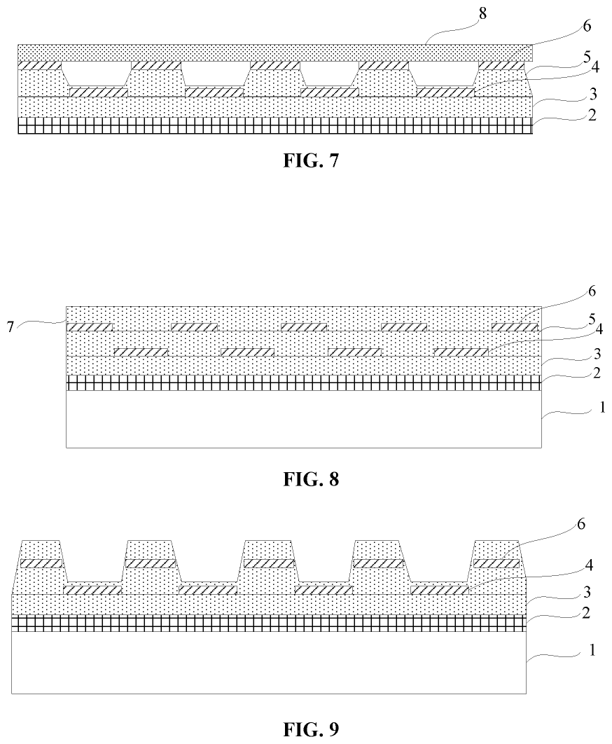

Step 7: as shown in FIG. 7, removing the flexible thin film 3 from the support plate 1.

The pressure sensing module is acquired through the above Steps 1 to 7. The pattern of first flexible layer 5 is deformed under the effect of the pressure, so the distance between each first pressure sensing electrode 4 and the corresponding second pressure sensing electrode 6 may change. At this time, the capacitance between each first pressure sensing electrode 4 and the corresponding second pressure sensing electrode 6 may change too, so as to convert the pressure signal into the electrical signal, thereby to achieve the pressure detection function.

### Second Embodiment

The method for manufacturing the pressure sensing module in this embodiment may include the following steps.

Step 1: as shown in FIG. 1, forming the release layer 2 and the flexible thin film 3 on the support plate 1.

The support plate 1 is a glass substrate or a quartz substrate. The release layer 2 is made of an inorganic insulation material. The flexible thin film 3 is made of polyimide, and has a thickness of 5 μm to 20 μm.

Step 2: as shown in FIG. 2, forming the first pressure sensing electrodes 4 and the signal line.

To be specific, a metal layer is deposited onto the flexible thin film 3 through sputtering or thermal evaporation. The metal layer is made of Cu, Al, Ag, Mo, Cr, Nd, Ni, Mn, Ti, Ta, W or an alloy thereof, and it is of a single-layered structure, or a multi-layered structure such as Cu/Mo, Ti/Cu/Ti, Mo/Al/Mo or Ti/Al/Ti. Next, a photoresist is applied onto the metal layer, and exposed through a mask plate, so as to form a photoresist reserved region corresponding a region where patterns of the first pressure sensing electrodes 4 and the signal line are located and a photoresist unreserved region corresponding to the other region. Next, the photoresist is developed, so as to fully remove the photoresist at the photoresist unreserved region, and maintain the photoresist at the photoresist reserved region. Finally, the metal layer at the photoresist unreserved region is etched off through an etching process, and the remaining photoresist is removed, so as to form the first pressure sensing electrodes 4 and the signal line. The first pressure sensing electrodes 4 are arranged on the flexible thin film 3 and spaced apart from each other. One end of the signal line is connected to each first pressure sensing electrode 4, and the other end is connected to the processing circuit.

Of course, each first pressure sensing electrode may also be made of a transparent conductive material, e.g., ITO, but not limited to metal.

Step 3: as shown in FIG. 3, forming the first flexible layer 5.

The first flexible layer 5 is made of polyimide, and has a thickness of 1 μm to 10 μm. The thickness of the first flexible layer 5 depends on a capacitance between each first pressure sensing electrode 4 and a corresponding second pressure sensing electrode 6.

Step 4: as shown in FIG. 4, forming the second pressure sensing electrodes 6 and the signal line.

To be specific, a metal layer is deposited onto the first flexible layer 5 through sputtering or thermal evaporation. The metal layer is made of Cu, Al, Ag, Mo, Cr, Nd, Ni, Mn, Ti, Ta, W or an alloy thereof, and it is of a single-layered structure, or a multi-layered structure such as Cu/Mo, Ti/Cu/Ti, Mo/Al/Mo or Ti/Al/Ti. Next, a photoresist is applied onto the metal layer, and exposed through a mask plate, so as to form a photoresist reserved region corresponding a region where patterns of the second pressure sensing electrodes 6 and the signal line are located and a photoresist unreserved region corresponding to the other region. Next, the photoresist is developed, so as to fully remove the photoresist at the photoresist unreserved region, and maintain the photoresist at the photoresist reserved region. Finally, the metal layer at the photoresist unreserved region is etched off through an etching process, and the remaining photoresist is removed, so as to form the second pressure sensing electrodes 6 and the signal line. The second pressure sensing electrodes 6 are arranged on the first flexible layer 5 and spaced apart from each other. A capacitor is formed between each second pressure sensing electrode 6 and the corresponding first pressure sensing electrode 4. Each second pressure sensing electrode 6 is arranged at a position corresponding to a gap between the adjacent first pressure sensing electrodes 4. An orthogonal projection of the gap between the adjacent first pressure sensing electrodes 4 onto the flexible thin film may fall within an orthogonal protection of the corresponding second pressure sensing electrode 6 onto the flexible thin film, or the orthogonal projection of each second pressure sensing electrode 6 onto the flexible thin film may fall within the orthogonal projection of the gap between the adjacent first pressure sensing electrodes 4 onto the flexible thin film, or the orthogonal protection of the gap between the adjacent first pressure sensing electrodes 4 onto the flexible thin film may coincide with the orthogonal projection of the corresponding second pressure sensing electrode 6 onto the flexible thin film. One end of the signal line is connected to each second pressure sensing electrode 4, and the other end is connected to the processing circuit.

Of course, each second pressure sensing electrode may also be made of a transparent conductive material, e.g., ITO, but not limited to metal.

Step 5: as shown in FIG. 8, forming a second flexible layer 7.

The second flexible layer 7 is made of polyimide, and has a thickness of 5 μm to 20 μm. The thickness of the first flexible layer 5 depends on a pressure detection range for the pressure detection.

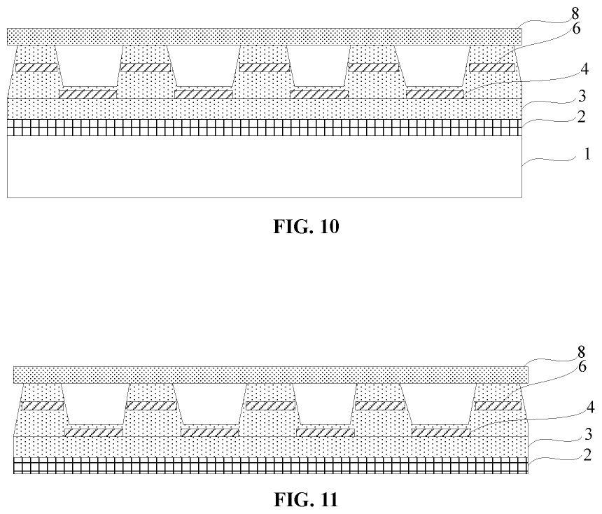

Step 6: as shown in FIG. 9, removing the entire second flexible layer 7 corresponding to the gap between the adjacent second pressure sensing electrodes 6 and at least a part of the first flexible layer 5 corresponding to the gap between the adjacent second pressure sensing electrodes 6.

A part of the first flexible layer 5 or the entire first flexible layer 5 at the gap between the adjacent second pressure sensing electrodes 6 is removed, so as to expose the corresponding first pressure sensing electrode 4. Through removing the entire second flexible layer 7 and at least a part of the first flexible layer 5 at the gap between the adjacent second pressure sensing electrodes 6, a pattern of the island-like first flexible layer 5 and a pattern of the island-line second flexible layer 7 are formed. Hence, the pattern of first flexible layer 5 is deformed under the effect of the pressure, so a distance between each first pressure sensing electrode 4 and the corresponding second pressure sensing electrode 6 may change. At this time, a capacitance between each first pressure sensing electrode 4 and the corresponding second pressure sensing electrode 6 may change too, so as to convert a pressure signal into an electrical signal, thereby to achieve a pressure detection function.

Step 7: as shown in FIG. 10, forming the flexile protection film 8. The flexible protection film 8 may also be made of polyimide.

Step 8: as shown in FIG. 11, removing the flexible thin film 3 from the support plate 1.

The pressure sensing module is acquired through the above Steps 1 to 8. The pattern of first flexible layer 5 is deformed under the effect of the pressure, so the distance between each first pressure sensing electrode 4 and the corresponding second pressure sensing electrode 6 may change. At this time, the capacitance between each first pressure sensing electrode 4 and the corresponding second pressure sensing electrode 6 may change too, so as to convert the pressure signal into the electrical signal, thereby to achieve the pressure detection function.

The present disclosure further provides in some embodiments an electronic device including the above-mentioned pressure sensing module.

The electronic device may be a display product, a robot or a wearable device. When the flexible thin film of the pressure sensing module is made of a transparent material, the resultant pressure sensing module is applied to a display product, e.g., any product having a display function, such as television, display, digital photo frame, mobile phone or flat-panel computer. When the flexible thin film of the pressure sensing module is node made of a transparent material, the resultant pressure sensing module is applied to a non-optical field, e.g., a robot or a wearable device.

In the embodiments of the present disclosure, the order of the steps is not limited to the serial numbers thereof. For a person skilled in the art, any change in the order of the steps shall also fall within the scope of the present disclosure if without any creative effort.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “one of” are merely used to represent the existence of at least one member, rather than to limit the number thereof. Such words as “include” or “including” intends to indicate that an element or object before the word contains an element or object or equivalents thereof listed after the word, without excluding any other element or object. Such words as “connect/connected to” or “couple/coupled to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

It should be appreciated that, in the case that such an element as layer, film, region or substrate is arranged “on” or “under” another element, it may be directly arranged “on” or “under” the other element, or an intermediate element may be arranged therebetween.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

1. A method for manufacturing a pressure sensing module, comprising:
providing a support plate;
forming a flexible thin film on the support plate;
forming first pressure sensing electrodes and second pressure sensing electrodes on the flexible thin film and at different levels, each second pressure sensing electrode being arranged at a position corresponding to a gap between two adjacent first pressure sensing electrodes, a distance between each first pressure sensing electrode and a corresponding second pressure sensing electrode being capable of changing under the effect of a pressure;
forming a flexible protection film covering the first pressure sensing electrodes and the second pressure sensing electrodes; and
removing the flexible thin film from the support plate.

2. The method according to claim 1, wherein when each second pressure sensing electrode is arranged at a position corresponding to the gap between the two adjacent first pressure sensing electrodes, an orthogonal projection of the second pressure sensing electrode onto the support plate is located between, and does not overlap, orthogonal projections of the two adjacent first pressure sensing electrodes onto the support plate.

3. The method according to claim 1, wherein when each second pressure sensing electrode is arranged at a position corresponding to the gap between the two adjacent first pressure sensing electrodes, an orthogonal projection of the second pressure sensing electrode onto the support plate is located between, and partially overlaps, orthogonal projections of the two adjacent first pressure sensing electrodes onto the support plate.

4. The method according to claim 1, wherein the forming the flexible thin film on the support plate comprises:
forming a release layer on the support plate; and
forming the flexible thin film on the release layer.

5. The method according to claim 1, wherein the forming the first pressure sensing electrodes and the second pressure sensing electrodes on the flexible thin film and at different levels comprises:
forming the first pressure sensing electrodes on the flexible thin film and spaced apart from each other,
forming a first flexible layer covering the first pressure sensing electrodes;
forming the second pressure sensing electrodes on the first flexible layer and spaced apart from each other, and
removing at least a part of the first flexible layer between the adjacent second pressure sensing electrodes.

6. The method according to claim 1, wherein the forming the first pressure sensing electrodes and the second pressure sensing electrodes on the flexible thin film and at different levels comprises:
forming the first pressure sensing electrodes on the flexible thin film and spaced apart from each other;
forming a first flexible layer covering the first pressure sensing electrodes;
forming the second pressure sensing electrodes on the first flexible layer and spaced apart from each other,
forming a second flexible layer covering the second pressure sensing electrodes; and
removing the second flexible layer between the adjacent second pressure sensing electrodes and at least a part of the first flexible layer between the adjacent second pressure sensing electrodes.

7. The method according to claim 5, wherein the removing at least a part of the first flexible layer between the adjacent second pressure sensing electrodes comprises removing a part of the first flexible layer corresponding to a gap between the adjacent second pressure sensing electrodes, or removing the entire first flexible layer corresponding to the gap between the adjacent second pressure sensing electrodes, so as to expose the corresponding first pressure sensing electrode.

8. The method according to claim 1, wherein the forming the first pressure sensing electrodes and the second pressure sensing electrodes on the flexible thin film and at different levels comprises forming the first pressure sensing electrodes and the second pressure sensing electrodes, each of which is made of metal, on the flexible thin film and at different levels.

9. A pressure sensing module, comprising:
a flexible thin film;
first pressure sensing electrodes and second pressure sensing electrodes arranged on the flexible thin film and at different levels, each second pressure sensing electrode being arranged at a position corresponding to a gap between two adjacent first pressure sensing electrodes, a distance between each first pressure sensing electrode and a corresponding second pressure sensing electrode being capable of changing under the effect of a pressure; and
a flexible protection film covering the first pressure sensing electrodes and the second pressure sensing electrodes.

10. The pressure sensing module according to claim 9, specifically comprising:
the flexible thin film;
the first pressure sensing electrodes arranged on the flexible thin film and spaced apart from each other;
a pattern of a first flexible layer, the pattern of the first flexible layer comprising a plurality of concaves and convexes arranged alternately, each concave corresponding to a corresponding first pressure sensing electrode; and
the second pressure sensing electrodes each arranged on a corresponding convex.

11. The pressure sensing module according to claim 10, further comprising:
a pattern of a second flexible layer covering the second pressure sensing electrodes, wherein an orthogonal projection of the pattern of the second flexible layer onto the flexible thin film falls within orthogonal projections of the convexes onto the flexible thin film.

12. The pressure sensing module according to claim 11, wherein the flexible thin film, the first flexible layer and the second flexible layer are each made of polyimide.

13. The pressure sensing module according to claim 12, wherein the flexible thin film, the first flexible layer and the second flexible layer are each made of transparent polyimide or yellow polyimide.

14. The pressure sensing module according to claim 9, wherein an orthogonal projection of the gap between the adjacent first pressure sensing electrodes onto the flexible thin film falls within an orthogonal projection of a corresponding second pressure sensing electrode onto the flexible thin film.

15. The pressure sensing module according to claim 9, wherein the orthogonal projection of the second pressure sensing electrode onto the flexible thin film falls within the orthogonal projection of the gap between the adjacent first pressure sensing electrodes onto the flexible thin film.

16. The pressure sensing module according to claim 9, wherein the orthogonal projection of the gap between the adjacent first pressure sensing electrodes onto the flexible thin film coincides with the orthogonal projection of the corresponding second pressure sensing electrode onto the flexible thin film.

17. The pressure sensing module according to claim 9, wherein the flexible thin film has a thickness of 5 μm to 20 μm, the first flexible layer has a thickness of 1 μm to 10 μm, and the second flexible layer has a thickness of 5 μm to 20 μm.

18. An electronic device, comprising the pressure sensing module according to claim 9.

19. The electronic device according to claim 18, wherein when the pressure sensing module is applied to an optical display product, the flexible thin film, the first flexible layer and the second flexible layer of the pressure sensing module are each made of transparent polyimide.

20. The electronic device according to claim 18, wherein when the pressure sensing module is applied to a robot or a wearable device, the flexible thin film, the first flexible layer and the second flexible layer of the pressure sensing module are each made of yellow polyimide.
